(19) United States
(12) Patent Application Publication
(10) Pub. No.: US 2015/0077325 A1
(43) Pub. Date: Mar. 19, 2015

(54) MOTION DATA BASED FOCUS STRENGTH METRIC TO FACILITATE IMAGE PROCESSING

(71) Applicants: Ron Ferens, Ramat Hasharon (IL); Dror Reif, Be'er-Yacoov (IL)

(72) Inventors: Ron Ferens, Ramat Hasharon (IL); Dror Reif, Be'er-Yacoov (IL)

(21) Appl. No.: 14/125,139

(22) PCT Filed: Sep. 13, 2013
(86) PCT No.: PCT/US2013/059606

§ 371 Date: Dec. 10, 2013

(51) Int. Cl. G06F 3/01

(52) U.S. Cl. CPC G06F 3/013; G06F 3/011
USPC 345/156

(57) ABSTRACT

Apparatuses, systems, media and/or methods may involve facilitating an image processing operation. User motion data may be identified when it user observes an image. A focus strength metric may be determined based on the user motion data. The focus strength metric may correspond to a focus area in the image. Also, a property of the focus strength metric may be adjusted. A peripheral area may be accounted for to determine the focus strength metric. A variation in a scan pattern may be accounted for to determine the focus strength metric. Moreover, a color may be imparted to the focus area and/or the peripheral area. In addition, a map may be formed based on the focus strength metric. The map may include a scan pattern map and a heat imp. The focus strength metric may be utilized to prioritize the focus area and/or the peripheral area in an image processing operation.

### BACKGROUND

Embodiments generally relate to facilitating image processing. More particularly, embodiments relate to determining a focus strength metric based on user motion data, wherein the focus strength metric corresponds to a focus area in the image and is to be utilized in an image processing operation.

A feature of an image may include an interesting part of the image, such as a corner, blob, edge, line, ridge and so on. Features may be important in various image operations. For example, a computer vision operation may require that an entire image be processed (e.g., scanned) to extract the greatest number of features, which may be assembled into objects for object recognition. Such a process may require, however, relatively large memory and/or computational power. Accordingly, conventional solutions may result in a waste of resources, such as memory, processing power, battery, etc., when determining (e.g., selecting, extracting, detecting, etc.) a feature which may be desirable (e.g., discriminating, independent, salient, unique, etc.) in an image processing operation.

### BRIEF DESCRIPTION OF THE DRAWINGS

The various at vantages of embodiments will become apparent to one skilled in the art by reading the following specification and appended claims, and by referencing the following drawings, in which:

FIG. 1 is a block diagram of example approach to facilitate image processing according to an embodiment;

FIGS. 2 and 3 are flowcharts of examples of methods to facilitate image processing according to embodiments;

FIG. 4 is a block diagram of an example of a logic architecture according to an embodiment;

FIG. 5 is a block diagram of an example of a processor according to an embodiment; and

FIG. 6 is a block diagram of an example of a system according to an embodiment.

### DETAILED DESCRIPTION

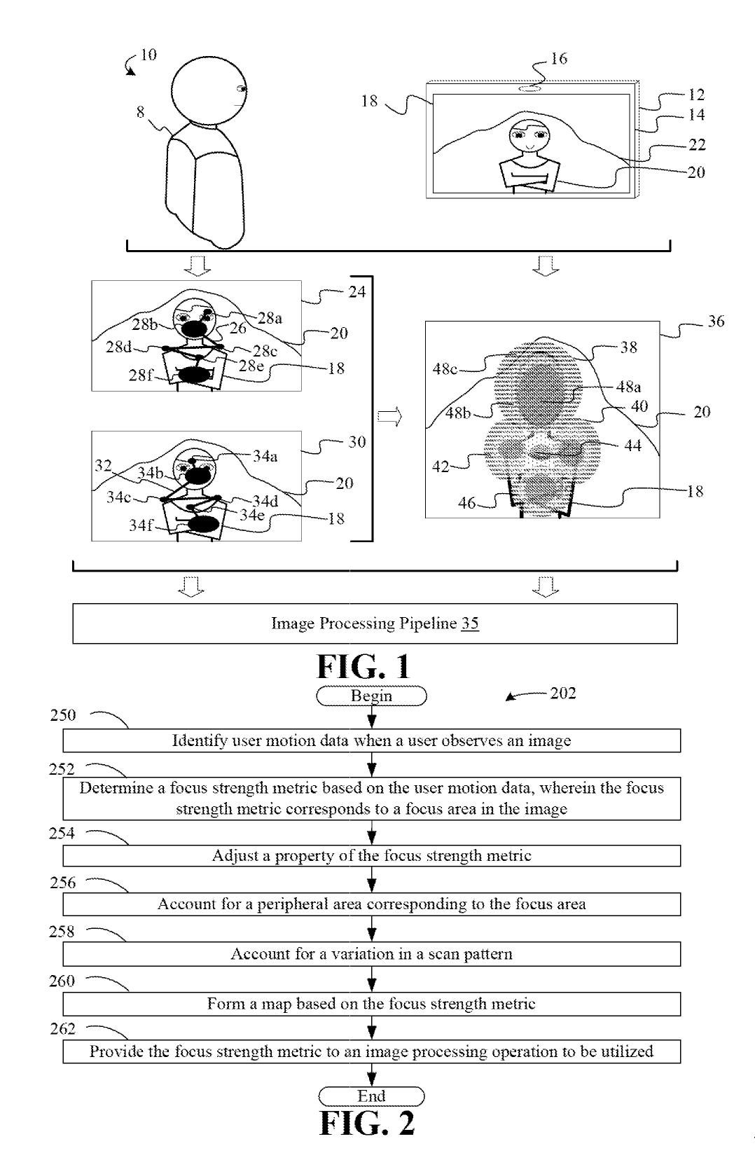

FIG. 1 shows an approach 10 to facilitate image processing according to an embodiment. In the illustrated example of FIG. 1, a user 8 in face an apparatus 12. The apparatus may include any computing device and/or data platform such as a laptop, personal digital assistant (PDA), wireless smart phone, media content player, imaging device, mobile Internet device (MID), any smart device such as a smart phone, smart tablet, smart TV, computer server, and so on, or any combination thereof. In one example, the apparatus 12 may include a relatively high-performance mobile platform such as a notebook having a relatively high processing capability (e.g., Ultrabook® convertible notebook, a registered trademark of Intel Corporation in the U.S. and/or other countries).

The illustrated apparatus 12 includes a display 14, which may include a touch screen display, an integrated display of a computing device, a rotating display, a 2D (two-dimensional) display, a 3D (three-dimensional display), a standalone display (e.g., a projector screen), and so on, or combinations thereof. The illustrated apparatus 12 also includes an image capture device 16, which may include an integrated camera of a computing device, a font-facing camera, a rear-facing camera, a rotating camera, a 2D camera, a 3D camera, a standalone camera (e.g., a wall mounted camera), and so on, or combinations thereof.

In the illustrated example, an image 18 is rendered via the display 14. The image 18 may include any data format. The data format may include, for example, a text document, a web page, a video, a movie, a still image, and so on, or combinations thereof. The image 18 may be obtained from any location. For example, the image 18 may be obtained from data memory, data storage, a data server, and so on, or combinations thereof. Accordingly, the image 18 may be obtained from a data source that is on- or off-platform, on- or off-site relative to the apparatus 12, and so on, or combinations thereof. In the illustrated example, the image 18 includes an object 20 (e.g., a person) and an object 22 (e.g., a mountain). The objects 20, 22 may include a feature, such as a corner, blob, edge, line, ridge, and so on, or combinations thereof.

In the illustrated example, the image capture device 16 captures user motion data when the user 8 observes the image 18 via the display 14. In one example, the image capture device 16 may define an observable area via a field of view. The observable area may be defined, for example, by an entire field of view, by a part of the field of view, and so on, or combinations thereof. The image capture device 16 may be operated sufficiently close enough to the user 8, and/or may include a sufficiently high resolution capability to capture the user motion data occurring in the observable area and/or the field of view. In one example, the apparatus 16 may communicate, and/or be integrated, with a motion module to identify user motion data including head-tracking data, face-tacking eye-tracking data, and so on, or combinations thereof. Accordingly, relatively subtle user motion data may be captured and/or identified such as, for example, the movement of an eyeball (e.g., left movement, right movement, up/down movement, rotation movement, etc.).

The apparatus 12 may communicate, and/or be integrated, with a focus metric module to determine a focus strength metric based on the user motion data. In one example, the focus strength metric may correspond to a focus area in the image 18. The focus area may relate to an area of the image in which the user focuses attention, interest, time, and so on, or combinations thereof. The focus area may include, for example, a focal point at the image 18, a focal pixel at the image 18, a focal region at the image 18, and so on, or combinations thereof. The focus area may be relatively rich with meaningful information, and the focus metric module may leverage an assumption that the user 8 observes the most interesting areas of the image 18. As described below, an input image such as the image 18 may be segmented based on the focus strength metric minimize areas processed (e.g., scanned, searched, etc.) in an image processing operation (e.g. to minimize a search area for feature extraction, a match area for image recognition, etc).

Accordingly, the focus strength metric may indicate the strength of focus by the user 8 at an area of the image 18. The focus strength metric may be represented in any form. In one example, the focus strength metric way be represented as a relative value, such as high, medium, low, and so on. The focus strength metric may be represented as a numerical value on any scale such as, for example, from 0 to 1. The focus strength metric may be represented as an average, a mean, as standard deviation from the average, the mean, etc.), and so on, or combinations thereof. The focus strength metric may be represented as a size (e.g., area, perimeter, circumference, radius, diameter, etc.), a color (e.g., any nm range in the visible spectrum), and so on, or combinations thereof.

The apparatus 12 may communicate, and/or be integrated, with a map generation module to form a map based on the focus strength metric. The map may define the relationship between the user motion data and the image 18 via the focus strength metric. In the illustrated example, the map may include a scan pattern map 24, 30, and/or a heat map 36. The scan pattern map 24 includes a scan pattern 26 having them strength metrics 28a to 28f, which may be joined according to the sequence in which the user 8 scanned the image 18. For example, the focus strength metric 28a may correspond to a focus area in the image 18 viewed first, and the focus strength metric 28f may correspond to another focus area in the image 18 viewed last. It should be understood that the focus strength metrics 28a to 28f may not be joined but may include sequence data indicating the order in which the user 8 observed the image 18. In addition, the focus strength metrics 28a to 28f are represented by size. For example, the scan pattern map 24 indicates that the user 8 focused most in the areas of the image 18 corresponding to focus strength metrics 28b and 28f since the circumference of the focus strength metrics 34b and 34f is the largest. The focus strength metrics 28a to 28f may be filled arbitrarily, such as where the same color is used, and/or may be rationally filled, as described below.

The scan pattern map 30 may include a second scan of the image 18 by the same user 8, may include the scan pattern for the image 18 by another user, and so on, or combinations thereof. The scan pattern map 30 includes a scan pattern 32 having focus strength metrics 34a to 34f, which may be joined according to the sequence in which the user scanned the image 18. In the illustrated example, the focus strength metric 34a may correspond to a focus area in the image 18 viewed first, and the focus strength metric 34f may correspond to another focus area in the image 18 viewed last. It should be understood that the focus strength metrics 34a to 34f may also not be joined. In addition, the focus strength metrics 34a to 34f are represented by size. For example, the scan pattern map 30 indicates that the user 8 focused most in the areas of the image 18 corresponding to focus strength metrics 34b and 34f since the circumference of the focus strength metrics 34b and 34f is the largest. The focus strength metrics 34a to 34f may be filled arbitrarily, such as where the same color is used, and/or may be rationally filled as described below.

The apparatus 12 may communicate, and/or be integrated, with an adjustment module to adjust as property of the focus strength metric. The adjustment may be based on any criteria, such as a gaze duration at the focus area. The gaze duration at the focus area may be based on head-motion data, face-motion data, eye-tracking data, and so on, or combinations thereof. For example, the movement of a head, a face, an eye, etc. of the user 8 may be tracked when the user 8 observes the image 18 to identify the focus area and/or adjust the property of the corresponding focus strength metric according to the time that the user 8 gazed at the focus area. The adjustment module may adjust any property of the focus strength metric. For example, the adjustment module may adjust the numerical value of the focus strength metric, the size of the focus strength metric, the color of the focus strength metric, and so on, or combinations thereof. In the illustrated example, the adjustment module adjusts the size (e.g., circumference) property of the focus strength metrics 28a to 28f and 34a to 34f based on a gaze duration at the focus area using eye-tracking data.

The apparatus 12 may communicate, and/or be integrated, with as scan pattern module to account for as variation in a scan pattern to determine the gaze strength metric. In the illustrated example, the scan patterns 26, 32 are generated for the scan pattern maps 34, 30, respectively, to account for a variation in the scan pattern caused by the manner in which the user 8 observes the image 18. It should be understood that the scan pattern module may generate a plurality of scan patterns on the same scan pattern map. The scan pattern module may also merge a plurality of scan patterns into is single scan pattern to account for a variation in the scan pattern caused by the manner in which the user 8 observes the image 18. In one example, the scan pattern module may calculate an average a scan patterns, a mean of scan patterns, and so on, or combinations thereof. For example, the size of the locus strength metrics 28f, 34f may be averaged, the location of the focus strength metrics 28f, 34f may be averaged, the focus strength metrics 28f, 34f may be used boundaries for a composite focus strength metric including the focus strength tries 28f, 34f, and so on, or combinations thereof.

In the illustrated example, the heat map 36 includes focus strength metrics 38 to 46, which may incorporate scan pattern data (e.g., scan pattern maps, scan patterns, scan pattern focus strength metrics scan pattern averages, etc.) obtained from the scan pattern maps 24, 30. It should be understood that a group of the focus strength metrics 38 to 46 may be combined, for example to provide a single focus strength region. For the purpose of illustration, the focus strength metrics 38 to 46 are described with reference to the focus strength metric 38. In the illustrated example, the focus strength metric 38 is determined based on the user motion data (e.g., eye-tracking data) identified when the user 8 observes the image 18, wherein the focus strength metric 38 corresponds to a focus area. For example, the heat map 36 indicates that the user 8 focused most in the area of the image 18 corresponding to the strength region 48a of the focus strength metric 38 since the size of the strength region 48a is the largest relative to the strength regions corresponding to the focus strength metrics 40 to 46.

The apparatus 12 may communicate, and/or be integrated, with a peripheral area module to account for a peripheral area corresponding to the focus area to determine the gaze strength metric. The peripheral area may relate to an area of the image which is proximate (e.g., near, surrounding, etc.) to the area where the user focuses attention, interest, time, and so on, or combinations thereof. The peripheral area may include meaningful information, wherein the focus metric module may leverage an assumption that the user 8 observes the most interesting areas of the image 18 and naturally includes peripheral area near the most interesting areas without directly focusing on the peripheral areas. Accordingly, the focus strength metric may indicate the strength of focus by the user 8 at a peripheral area relative to the focus area of the image 18.

In the illustrated example, the peripheral module may account for peripheral areas of the image 18 corresponding to the strength regions 48b, 48c of the strength metric 38. In one example, the peripheral module may account for the peripheral areas based on any criteria, such as a distance from a focal point (e.g., a central image pixel, an image area, etc.) of the focus area a number of pixels from a focal point of the focus area, a range of view (e.g., based on the distance to the image, size of the display, etc.), and so on, or combinations thereof. For example, the peripheral module may arrange the strength regions 48b, 48c about the focus area using a predetermined distance from an outer boundary of the strength region 48a, from the center of the strength region 48a, and so on, or combinations thereof. In the illustrated example, the peripheral module may also account for an overlap of the focus strength metrics 38 to 46, wherein a portion of corresponding strength regions my be modified (e.g., masked). For example, the focus strength metric 44 includes air innermost region and an intermediate region with a mash outermost region, while the focus strength metrics 38, 40, 42, 46 include three strength regions (e.g., an innermost region, an intermediate strength region, kind an outermost strength region), which may include varying degrees of modification (e.g., masking) based on the size of adjoining focus strength metrics.

The focus strength metric 38 may be represented by a color, a size, and so on, or combinations thereof. Thus, the strength regions 48a to 48c may be adjusted by the adjustment module. In one example, the adjustment module may adjust the color, the size, etc., based on any criteria, including a gaze duration at the focus area. For example, the adjustment module may impart a color to the focus area by assigning, a cobs to the strength region 48a based on the gaze duration of the user 8 at the corresponding focus area of the image 18. The color assigned to the strength region 48a may be in one part of the visible spectrum. The adjustment module may also impart as color to the peripheral areas by assigning respective colon to the strength regions 48b, 48c. The respective colors assigned to the regions 48b, 48c may be in another part of the visible spectrum relative to the color assigned to the strength region 48a. In the illustrated example, the adjustment module may impart as color in an approximate 620 to 750 nm range (e.g., red) of the visible spectrum to the focus area via strength region 48a. Accordingly, the color “red” may indicate that the user 8 gazed at the corresponding focus area for a relatively long tune.

The adjustment module may also impart as color in an approximate 570 to 590 nm range (e.g., yellow) of the visible spectrum to an intermediate peripheral area via strength region 48a, and/or impart a color in an approximate 380 to 150 nm range (e.g., violet) of the visible spectrum to an outermost peripheral area via the strength region 45c. Accordingly, a color of “violet” may indicate that the user 8 did not gaze at the corresponding area (e.g., it is a peripheral area), but since it is imparted with a color via the strength region 48c, the corresponding area may include interesting information. Alternatively, the color of “violet” may indicate that the user 8 did not gaze at the corresponding area (e.g., it is a peripheral area) and can be neglected as failing to satisfy a threshold value (e.g., less than approximately 450 nm) even if imparted with a color, described in detail below. It should be understood that the scan pattern module may also account for a variation in any scan pattern, as described above, for the color property to arrive at the size and/or color of the strength metrics, including the corresponding strength regions, for the heat map 36.

The maps 24, 30, 36, and/or portions thereof such as the focus strength metrics thereof, the strength regions thereof, the scan patterns thereof, etc. may be forwarded to the image processing pipeline 35 to be utilized in an image processing operation. The image processing pipeline may include any component and/or stage of the image processing operation, such as an application, an operating system, a central processing unit (CPU), as graphical processing unit (GPU), a visual processing unit (VPU), so on, or combinations thereof. The image processing operation may include any operation, such as computer vision, pattern recognition, machine learning, and so on, or combinations thereof. The image processing operation may be implemented in any context, such as in medical diagnosis, text processing, drug discovery, data analysis, handwriting recognition, image tracking, object detection and recognition, image indexing and retrieval, and so on, or combinations thereof. In one example, the focus strength metrics 28a to 28f, 34a to 34f, and/or 38 to 46 may be provided to an image operation module (e.g., a feature extraction module, an image recognition module, etc.) that is in communication, and/or integrated, with the image processing pipeline 35 to perform an operation (e.g. a feature extraction operation, an image recognition operation, etc.). It should be understood that the focus strength metrics 28a to 28f, 34a to 34f, 38 to 46 may be provided individually, or may be provided via the maps 24, 30, 36.

The image processing pipeline 35 may prioritize the focus areas and/or the peripheral areas in the image processing operation if a focus strength metric satisfies a threshold value, an for may neglect the focus areas and/or the peripheral areas in the image processing operation if the focus strength metric does not satisfy the threshold value. The threshold value may be set according to the manner in which the focus strength metric is represented. In one example, the threshold value may include the value “medium” if the focus strength metric is represented as a relative value, such as high, medium, and low. The threshold may include a value of “0.5” if the focus strength metric is represented as a numerical value, such as 0 to 1. The threshold value may include as predetermined size (e.g., of diameter, radius, etc.) if the focus strength metric is represented as a size, such as a circumference. The threshold may include a predetermined color of “red” if the focus strength metric is represented as a color, such as any nm range in the visible spectrum.

Accordingly, with regard to the focus strength metric 38, the focus areas and/or the peripheral areas of the image 18 may be prioritized and/or neglected based on the strength regions 48a to 48c. In one example, the focus areas and peripheral areas that correspond to the strength regions 48a to 48c may be prioritized relative to other areas associated with focus strength metrics (e.g., smaller focus strength metrics), relative to areas without any corresponding focus strength metrics, and so on, or combinations thereof. In another example, the focus area may be prioritized corresponding to the peripheral areas. The image processing pipeline 35 may involve, for example, an image processing operation including a feature extraction operation wherein an input to the feature extraction operation includes the image 18. Conventionally, the feature extraction operation may scan the entire image 18 to determine and/or select features (e.g., orientated edges, color opponencies, intensity contrasts, etc.) for object recognition. To minimize waste of resources, the image 18 may be input with the heat map 36 and/or portions thereof, for example, to rationally process (e.g., search) relatively information-rich areas by prioritizing and/or neglecting areas of the image 18 based on to the strength regions 48a to 48c.

In one example, the strength regions 48a to 48c may cause the feature extraction operation to prioritize areas to scan in the image 18 that correspond to the region 48a (and/or regions with similar properties) over any peripheral region such as 48b, 48c, to prioritize area which correspond to an intermediate peripheral region such as 48b over areas which correspond to an outermost peripheral region such as 48c, to prioritize areas which correspond to, all strength regions such as 48a to 48c over areas lacking a corresponding strength region, and so on, or combinations thereof. In addition, the heat map 36 and/or portions thereof, for example, may be implemented to cause the feature extraction operation to neglect areas of the image 18. For example, the strength regions 48a to 48c may cause the feature extraction operation to ignore all areas in the image 18 that do not correspond to the region 48a (and/or similar regions with similar properties), that do not correspond to the regions 48a to 48c (and/or similar regions with similar properties), that lack a corresponding strength region, and so on, or combination thereof. The feature extraction operation may then utilize features extracted from the relatively information-rich areas to recognize objects in the image for implementation in any context.

In a further example, the image processing pipeline 35 may involve an image processing operation including an image recognition operation. To minimize waste of resources, the heat map 36 and/or portions thereof for example, may be utilized as input to the image recognition operation. For example, a reference input (e.g., a template input) and/or a sample input may include a signature, such as a scan pattern, a focus strength metric (e.g., as collection, a combination, etc), and so on, or combinations thereof. With regard to the focus strength metric 38, the signature may include a position of the strength regions 48a to 48c, a property of the strength regions 48a to 48c (e.g., color, size, shape, strength region number, etc.), as lack of a focus strength metric (e.g., in a part of the image, etc.), and so on, or combinations thereof. A match may be determined between the signature of the reference input and the signature of the sample input, which may provide a confidence to be utilized to recognize an image, an object in the image, and so on, or combinations thereof. The confidence level may be represented in any form such as a relative value (e.g., low, high, etc.), a numerical value (e.g., approximately 0% match to 100% match), and so on, or combinations thereof.

The focus areas and/or the peripheral areas may be prioritized and/or neglected based on threshold values, as described above, for example by causing the image recognition operation to prioritize the areas which correspond to the region 48a (and/or similar regions with similar properties) in the match, by causing the image recognition operation to ignore all area which lack a corresponding strength region in the match, and so on, or combinations thereof. Moreover, prioritizing and/or neglecting areas may relatively quickly eliminate the quantity of reference input (e.g., number of templates used). For example, the signature of the sample input may relatively quickly eliminate a reference input that does not include a substantially similar scan pattern (e.g., based on a threshold, a property, location, etc.), a substantially focus strength metric (e.g., based on a threshold, a property, a location, etc.), and so on, or combinations thereof. In this regard, the reference input may be rationally stored and/or fetched according the corresponding signatures (e.g., based on similarity of focus strength metric properties for the entire image, for a particular portion of the image, etc).

In addition, the signature of the reference input and/or the signature of the sample input may be relatively unique, which may cause the image recognition operation to relatively easily recognize an image, an object within the image and so on, or combinations thereof. For example, the signature of the image 18 may be unique and cause the image recognition operation to relatively easily recognize the image (e.g., recognize that the image is a famous printing), to relatively easily fetch the reference input for the image (e.g., for the famous painting) to determine and/or confirm the identity of the image via the confidence level, to relatively easily rule out reference input to fetch, and so on, or combinations thereof.

Accordingly, the focus areas and/or the peripheral areas may be prioritized when, for example, corresponding focus strength metrics satisfy a threshold value (e.g., falls within the nm range, etc.), and/or may be neglected, for example, when corresponding focus strength metrics do not satisfy the threshold value (e.g., falls outside of the urn range, etc.). It should be understood that it may not be necessary to process an entire image to select, extract, and/or detect a feature which may be discriminating, independent, salient, and/or unique, although the entire image 18 may be scanned such as after the prioritized areas are searched.

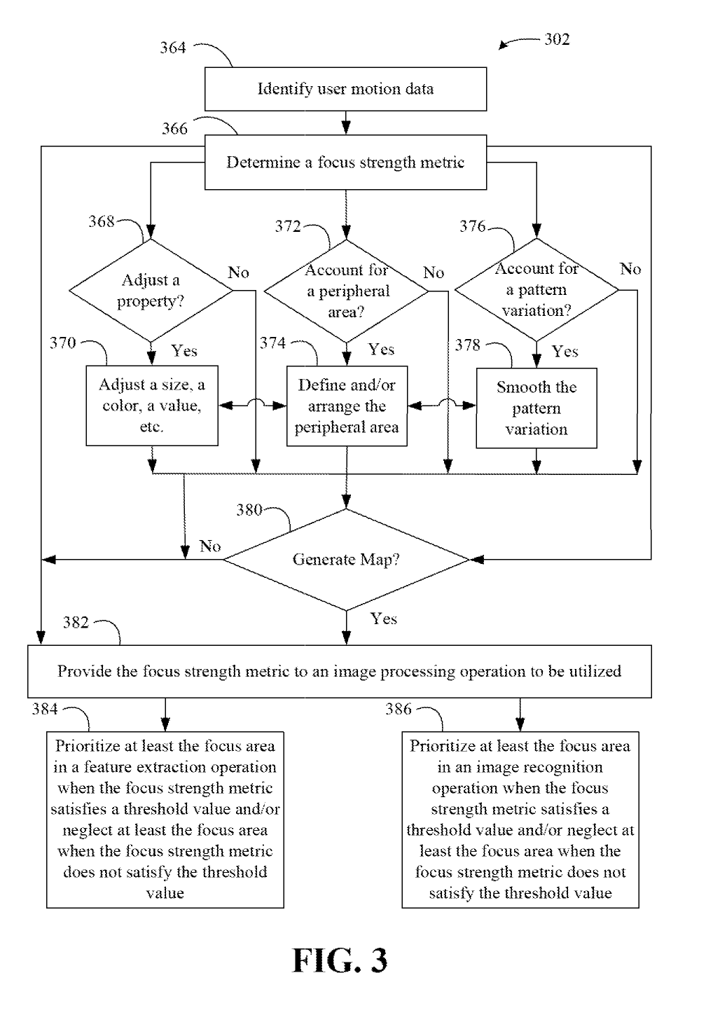

Turning now to FIG. 2, a method 202 is shown to facilitate image processing according to an embodiment. The method 202 may be implemented as a set of logic instructions and/or firmware stored liar a machine- or computer-readable storage medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), CMOS or transistor-transistor logic (TTL) technology, or any combination thereof. For example, computer program code to carry out operations shown in the method 202 may be written in any combination of one or more programming languages, including an object oriented programming language such as C++ or the like and conventional procedural programming languages, such as the “C” programming language or similar programming languages. Moreover, the method 202 may be implemented using any of the herein mentioned circuit technologies.

Illustrated processing block 250 provides for identifying user motion data when a user observes an image. The image may include any data format, such as a text document, is web page, a video, a movie, a still image, and so on, or combinations thereof. The image may also be obtained from any location, such as from data memory, data storage, a data server, and so on, or combinations thereof. Thus, the image may be obtained from a data source that is on- or off-platform, on- or off-site relative, and so on, or combinations thereof. In addition, the image may be displayed via a display of an apparatus, such as the display 14 of the apparatus 12 described above. Moreover, the motion data may be captured by an image capture device, such as the image capture device 16 of the apparatus 12 described above. The user motion data may include, for example, head-tracking data, face-tracking eye-tracking data, and so on, or combinations thereof. Accordingly, relatively subtle user motion data may identify, for example, the movement of an eyeball (e.g., left movement, right movement, up/down movement, rotation, etc.).

Illustrated processing block 252 provides for determining a focus strength metric based on the user motion data, wherein the focus strength metric corresponds to as focus area in the image. The focus area may relate to an area of the image in which the user focuses attention, interest, time, and so on, or combinations thereof. In one example, the focus strength metric may indicate the strength of focus by the user at an area of the image. The focus area may include a focal point at the image, a focal pixel at the image, a focal region at the image, and so on, or combinations thereof. The focus strength metric may be represented in any form. For example, the focus strength metric may be represented as a relative value, such as high, medium, low, as numerical value on any scale, such as from 0 to 1, an average, a mean, a standard deviation (e.g., from the average, the mean, etc.), a size (e.g., area, perimeter, circumference, radius, diameter, etc.), a color (e.g., any urn range in the visible spectrum), and so on, or combinations thereof.

Instated processing clock 254 provides for adjusting a property of the focus strength metric. The adjustment may be based on any criteria, such as a gaze duration at the focus area. The gaze duration at the focus area may be based on head motion data, face-motion data, eye-tracking data, and so on, or combinations thereof. For example, the movement of a head, a face, an eye, etc. of the user may be tracked when the user observes the image to identify the focus area and/or to adjust the property of a corresponding focus strength metric based on the time that the user gazed at the focus area. In addition, any property of the focus strength metric may be adjusted, such as the numerical value of the focus strength metric, the size of the feats strength metric, the color of the focus strength metric, and so on, or combinations thereof. In one example, the size (e.g., circumference) of the focus strength metric is adjusted based on a gaze duration at the focus area using eye-tracking data. In another example, while the focus strength metric may be filled arbitrarily, such as where the same color is used the focus strength metric may also be rationally filled, such as where the color is adjusted based on a gaze duration at the focus area (e.g., using eye-tracking data).

Illustrated processing block 256 provides for accounting for a peripheral area corresponding to the focus area to determine the focus strength metric. The peripheral area may relate to an area of the image which is proximate (e.g., near, surrounding, etc.) to the area where the user focuses attention, interest, time, and so on, or combinations thereof. In one example, the focus strength metric may indicate the strength of focus by the user at a peripheral area relative to the focus area of the image. The peripheral area may be accounted for based on any criteria, such as a distance from a focal point (e.g., a central image pixel, an image area, etc.) of the focus area, a number of pixels from a focal point of the focus area, a range of view for the focus area (e.g. based on the distance to the image, size of the display, etc.), and so on, or combinations thereof. In one example, strength regions (of the focus strength metric) corresponding to the peripheral area may be arranged about the focus area at a predetermined distance from an outer boundary of the strength region corresponding to the focus area, from the center thereof, and so on, or combinations thereof.

Additionally, a color may be imparted to the focus area in one part of the visible spectrum and a color may be imparted to the peripheral area in another part of the visible spectrum. In one example, a color in an approximate 620 to 750 nm range of the visible spectrum may be imparted to the focus area by assigning the “red” color to as corresponding focus strength metric and/or strength region thereof. In another example, a color in an approximate 380 to 450 nm range of the visible spectrum may be imparted to an outermost peripheral area by assigning the “violet” color to a corresponding focus strength metric and/or strength region thereof.

Instated processing block 258 pro ides for accounting for a variation in a scan pattern to determine the focus strength metric. It one example, a plurality of scan patterns are generated to account as variation in the scan patterns caused by the manner in which the user observes the image. In another example, a plurality of scan patterns may be generated for respective maps, and/or may be generated on the is map to account for the variation in the scan patterns. The plurality of scan patterns may be merged into a single scan pattern to account for the variation in the scan patterns. For example, an average of the scan patterns may be calculated, a mean of scan patters may be calculated, a standard deviation of the scan patterns may be calculated, and so on, or combinations thereof. Accordingly, for example, the size of the focus strength metrics may be averaged, the location of the focus strength metrics may be averaged, the focus strength metrics may be used boundaries for a composite focus strength metric including the focus strength metrics and so on, or combinations thereof.

Illustrated processing block 260 provides for forming a map based on the focus strength metric. The map may define the relationship between the user motion data and the image via the focus strength metric. In one example, the map may include a scan pattern map and/or a heat map. The scan pattern map may include a scan pattern having focus strength metrics joined according to the sequence in which the user scanned the image. The scan pattern map may, in another example, include focus strength metrics that are not joined. The heat map may incorporate scan pattern data (e.g. scan pattern map scan pattern, scan pattern focus strength metrics, scan pattern averages, etc.) obtained from the scan pattern map. A group of the focus strength metrics may be combined, for example to provide a single focus strength metric.

Illustrated processing block 262 provides the focus strength metric to an image professing operation to be utilized. In one example, the scan pattern map, the heat map, and/or: portions thereof (e.g., focus strength metrics thereof the strength regions thereof, scan patterns thereof, etc.) may be forwarded to an image processing operation. The image processing operation may include any operation, such as computer vision, pattern recognition, machine learning, and so on, or combinations thereof. The image processing operation may be implemented in any context, such as in medical diagnosis, text processing, drug discovery, data analysis, handwriting recognition, image tracking, object detection and recognition, image indexing and retrieval, and so on, or combinations thereof. In one example, the focus strength metric may be provided to a feature extraction operation and/or an image recognition operation. It should be understood that the focus strength metric may be provided individually, and/or may be provided via a map.

The focus strength metric may be utilized by prioritizing the theirs area and/or peripheral area in the image processing operation if the focus strength metric satisfies as threshold value, and/or by neglecting the focus area and/or peripheral area if the focus strength metric does not satisfy the threshold value. The threshold value may be set according to the manner in which the focus strength metric is represented. In one example, the threshold value may be set to “medium” if the focus strength metric is represented as a relative value, such as high, medium, and low, may be set to “0.5” if the focus strength metric is represented as a numerical value, such as 0 to 1, may be set to a predetermined size (e.g., of diameter, radius, etc.) if the focus strength metric is represented as a size, such as a circumference, may be set to the color “red” if the focus strength metric is represented as a color, such as any nm range in the visible spectrum, and so on, or combinations thereof. Accordingly, the focus areas and/or the peripheral areas of the image may be prioritized and/or neglected based en the focus strength metrics the strength regions).

In one example involving a feature extraction operation, the image may be combined with the heat map in a pre-processing step to segment the image and/or to prioritize the areas of the image to be processed (e.g., searched). The feature extraction operation may then use the features extracted from the focus areas and/or peripheral areas to recognize objects in the image. In another example involving the image recognition operation, the scan pattern map and/or the heat map may be used a reference input (e.g., a template input) having a signature (e.g., as scan pattern, a collection of focus strength metrics, etc.) to be used to recognize a sample input having a corresponding signature (e.g., a corresponding scan pattern, a corresponding collection of focus strength metrics, etc.). A match may be determined between the signatures, which may provide a confidence level to recognize the image (e.g., features thereof objects thereof, the image as a whole, etc.).

Accordingly, the focus areas and/or the peripheral areas may be prioritized when corresponding focus strength metric satisfy a threshold value (e.g., falls within the nm range of the color “red”, etc.), and/or may be neglected when corresponding focus strength metrics do not satisfy the threshold value (e.g. falls within the nm range of the color “violet”, etc.). It should be understood that it may not be necessary to process an entire image to select, extract, and/or detect a feature that may be discriminating, independent, salient, and/or unique, although the entire image 18 may be scanned such as after the prioritized areas are searched.

FIG. 3 shows a flow of a method 302 to facilitate image processing according to an embodiment. The method 302 may be implemented using any of the herein mentioned technologies. Illustrated processing block 364 may identify user motion data. For example, the user motion data may include eye-tracking data. Illustrated processing block 366 may determine as ideas strength metric based on the user motion data. In one example, the focus strength metric corresponds to a focus area in the image. A determination may be made at block 368 to adjust a property of the focus strength metric. The property may include a size of the focus strength metric, as color of the focus strength metric, a numerical value of the focus strength metric, a relative value of the focus strength metric, and so on, or combination thereof. If not, the process moves to block 380 and/or to block 382. If so, the illustrated processing block 370 adjusts a size, a color, etc. of the focus strength metric. A determination may be made at block 372 to account for a peripheral area. If not, the process moves to the block 380 and/or to the block 382. If so, the illustrated processing block 374 defines the peripheral area (e.g., intermediate region of a focus strength metric, outermost region or a focus strength metric, numerical value of the peripheral area, etc.) and/or arranges the peripheral area relative to the focus area (e.g., proximate, surrounding, etc.).

A determination may be made at processing block 376 to account for a can pattern variation. If not, the process moves to the block 380 and/or to the block 382. If so, the illustrated processing block 378 may smooth the pattern variations by providing multiple scan patterns, generating a plurality of scan patterns for respective scan pattern maps, generating a plurality of scan patterns on the same scan pattern, merging a plurality of scan patterns into a single scan pattern, and so on, or combinations thereof. A determination may be made at processing block 380 to generate a map. In one example, the map may include a scan pattern map and/or a heat map. If not, the process moves to block 382. The block 380 may receive the focus strength metric from the processing block 366, the processing block 370, the processing block 374, and/or the processing block 378. Accordingly, it should be understood that the input from the processing block 366 at the block 380 may cause a determination of adjustment and/or accounting at the block 380. If the determination is made at block 380 to generate the map, the processing block 382 provides the focus strength metric via the map to an image processing operation to be utilized.

In the illustrated example, the processing block 382 may also receive the focus strength metric from the processing block 366, the processing block 370, the processing block 374, and/or the processing block 378. Illustrated processing block 384 may prioritize at least the focus area in a feature extraction operation if the focus strength metric satisfies a threshold value, and/or may neglect at least the focus if the focus strength metric does not satisfy the threshold value. Illustrated processing block 386 may prioritize at least the focus area in an image recognition operation if the focus strength metric satisfies as threshold value, and/or may neglect at least the focus if the focus strength metric does not satisfy the threshold value.

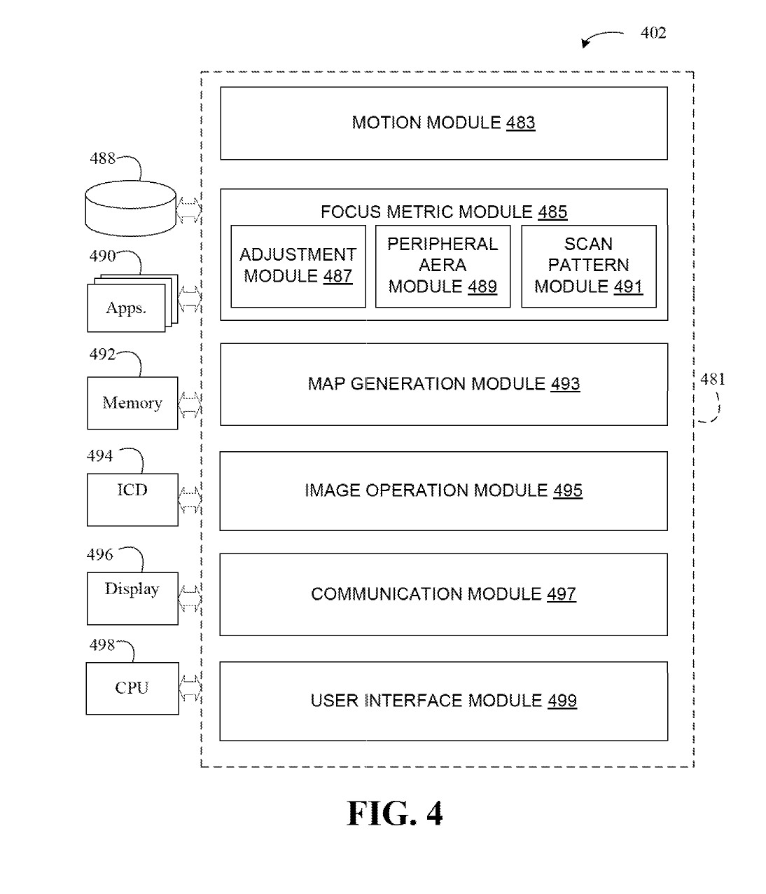

Turning now to FIG. 4, an apparatus 402 is shown including a logic architecture 481 to facilitate image processing according to an embodiment. The logic architecture 481 may be generally incorporated into a platform such as such as a laptop, personal digital assistant (PDA), wireless smart phone, media player, imaging device, mobile Internet device (MID), any smart device such as a saint phone, smart tablet, smart TV, computer server, and so on, or combinations thereof. The logic architecture 481 may be implemented in an application, operating system, media framework, hardware component, and so on, or combinations thereof. The logic architecture 481 may be implemented in any component of an image processing pipeline, such as a network interface component, memory, processor, hard drive, operating system, application, and so on, or combinations thereof. For example, the logic architecture 481 may be implemented in a processor, such as a central processing unit (CPU), a graphical processing unit (GPU), a visual processing unit (VPU), a sensor, an operating system, an application, and so on, or combinations thereof. The apparatus 402 may include and/or interact with storage 488, applications 490, memory 492, an image capture device (ICD) 494, display 496, CPU 498, and so on, or combinations thereof.

In the illustrated example, the logic architecture 481 includes as motion module 483 to identify user motion data. In one example, the user motion data may include head-tracking data, face-tracking eye-tracking data, and so on, or combinations thereof. For example, the head-tracking data way include movement of the head of a user, the face-tracking data may include the movement, of the face of the user, the eye-tracking data may include the movement of the eye of the user, and so on, or combinations thereof. The movement may be in any direction, such as left movement, fight movement, up/down movement, rotation movement, and so on, or combinations thereof.

Additionally, the illustrated logic architecture 481 includes a focus metric module 485 to determine a focus strength metric based on the user motion data. In one example, the focus strength metric corresponds to a focus area in the image. The focus area may relate to an area of the image in which the user focuses attention, interest, time, and so on, or combinations thereof. The focus strength metric may indicate the strength of focus by the user at an area of the image. The focus area may include a focal point at the image, as focal pixel at the image, as focal region at the image, and so on, or combinations thereof. The focus strength metric may be represented in any form. For example, the focus strength metric may be represented as a relative value, such a high, medium, low, a numerical value on any such as from 0 to 1, an average, a mean, a standard deviation (e.g., from the average, the mean, etc.), a size (e.g., area, perimeter, circumference, radius, diameter, etc.), a color (e.g., any nm range in the visible spectrum), and so on, or combinations thereof.

In the illustrated example, the focus metric module 485 includes an adjustment module 487 to adjust a property of the focus strength metric. The adjustment module 487 may adjust the property based on any criteria, such as a gaze duration at the focus area. The gaze duration at the focus area may be based on head-motion data, face-motion data, eye-tracking data, and so on, or combinations thereof. In addition, the adjustment module 487 may adjust any property of the focus strength metric, such as the numerical value of the focus strength metric, the size of the focus strength metric, the color of the focus strength metric, and so on, or combinations thereof. In one example, the adjustment module 487 may adjust the size (e.g., circumference) of the focus strength metric based on a gaze duration at the focus area rising eye-tracking data. In another example, the adjustment module 487 may arbitrarily fill the focus strength metric using the same color, and/or may rationally fill the focus strength metric by using a color is based on a gaze duration at the focus area (e.g., using eye-tracking data).

In the illustrated example, the focus metric module 485 includes a peripheral area module 489 to account for a peripheral area corresponding to the focus area to determine the focus strength metric. The peripheral area may relate to an area of the image which is proximate (e.g., near, surrounding, etc.) to the area where the user focuses attention, interest, time, and so on, or combinations thereof. Thus, the focus strength metric may indicate the strength of focus by the user at a peripheral area relative to the focus area of the image. In one example, the peripheral area module 489 may account for the peripheral area based on any criteria, such as a distance from a focal point (e.g., a central image pixel, an image area, etc.) of the focus area, a number of pixels from a focal point of the focus area, a range of view for the focus area (e.g., based on the distance to the image, size of the display, etc.), and so on, or combinations thereof. The peripheral area module 489 may define the peripheral area (e.g. intermediate region, outermost region, numerical value of the peripheral area, etc.) and/or may arrange the peripheral area relative to the focus area (e.g., proximate, surrounding, etc.).

Accordingly, a color may be imparted to the focus area in one part of the visible spectrum and a color may be imparted to the peripheral area in another part of the visible spectrum. In one example, a color in an approximate 620 to 750 nm range of the visible spectrum may be imparted to the focus area by assigning the “red” color to as corresponding focus strength metric and/or strength region thereof. In another example, a color in an approximate 380 to 450 nm range of the visible spectrum may be imparted to an outermost peripheral area by as the “violet” color to a corresponding focus strength metric and/or strength region thereof. The adjustment module 487 may impart the color to the focus area and/or the peripheral area.

In the illustrated example, the focus metric module 485 includes a scan pattern module 491 to account for a variation in a scan pattern to determine the focus strength metric. In one example, the scan pattern module 491 generates a plurality of scan patterns to account for a variation in the scan patterns caused by the manner in which the user observes the image. In another example, the scan pattern module 491 generates a plurality of scan patterns for respective maps, and/or generates the plurality of scan patterns for the same map. The scan pattern module 491 may merge the plurality of scan patterns into a single scan pattern. For example, the scan pattern module 491 may calculate an average of the scan patterns, may calculate a mean of scan patters, may calculate a standard deviation of the scan patterns, may overlay the scan patterns, and so on, or combinations thereof. The scan pattern module 491 may average the size of focus strength metrics, average the location of the focus strength metrics, use the focus strength metrics as boundaries for a composite focus strength metric including the focus strength metrics (e.g., including an area between two hams strength metrics spaced apart, overlapping, etc.), and so on, or combinations thereof, whether or not the focus strength metrics are joined, whether or not connected according to viewing order, whether or not connected independently of as viewing order, and so on, or combinations thereof.

Additionally, the illustrated logic architecture 481 includes a map generation module 493 to form a map based on the focus strength metrics. The map may define the relationship between the user motion data and the image via the focus strength metric. In one example, map generation module 493 may form a scan pattern map and/or a heat map. The scan pattern map may include a scan pattern having focus strength metrics joined, for example, according to the sequence in which the user scanned the image. The scan pattern map may, in another example, include focus strength metrics that are not joined. The map generation module 493 may incorporate scan pattern data (e.g., scan pattern map, scan pattern, scan pattern focus strength metrics, scan pattern averages, etc.) obtained from the scan pattern map into the heat map. The map generation module 493 may combine a group of the focus strength metrics to for example, provide a single focus strength metric.

Additionally, the illustrated logic architecture 481 includes an image operation module 495 to implement an operation involving the image. The image operation module 495 may implement any image processing operation, such as computer vision, pattern recognition, machine learning, and so on, or combinations thereof. The image processing operation may be implemented by the image operation module 495 in any context, such as in medical diagnosis, text processing, drug discovery, data analysis, handwriting recognition, image tracking, object detection and recognition, image indexing and retrieval, and so on, or combinations thereof. In one example, the scan pattern map, the heat map, and/or portions thereof (e.g., focus strength metrics thereof, the strength regions thereof, scan patterns thereof, etc.) may be forwarded to an image operation module 495. For example, the focus strength metric may be provided to a feature extraction operation and/or an image recognition operation.

The image operation module 495 may prioritize the focus area and/or peripheral area in the image processing operation if the focus strength metric satisfies a threshold value, and/or may neglect the focus area and/or peripheral area if the focus strength metric does not satisfy the threshold value. The threshold value may be set according to the manner in which the focus strength metric is represented. In one example involving a feature extraction operation, the image may be combined with the heat map in a pre-processing step to segment the image, and/or to prioritize the areas of the image to be processed (e.g., searched) by the image operation module 495. The feature extraction operation implemented by the image operation module 495 may then use the features extracted from the focus areas and/or peripheral areas to recognize objects in the image. In another example involving the image recognition operation, the scan pattern map and/or the heat map may be used by the image operation module 495 as a reference input (e.g., a template input) having a signature (e.g., a scan pattern, a collection of focus strength metrics, etc.) to recognize a sample input having a corresponding signature (e.g., as corresponding scan pattern, as corresponding collection of them strength metrics, etc.). A match may be determined between the signatures, which may provide a confidence level to recognize the image (e.g., features thereof, objects thereof, the image as a whole etc.)

Accordingly, the focus areas and/or the peripheral areas may be prioritized when corresponding focus strength metric satisfy a threshold value (e.g., falls within the nm range of the color “red”, etc.), and/or may be neglected when corresponding focus strength metrics do not satisfy the threshold value (e.g., falls within the run range of the color “violet” etc.). It should be understood that it may not be necessary to process an entire image to select, extract, and/or detect a feature that may be discriminating, independent, salient, and/or unique, although the entire image 18 (FIG. 1) may be scanned such as alley the prioritized areas are searched.

Additionally, the illustrated logic architecture 481 includes as communication module 497. The communication module may be in communication, and/or integrated, with a network interface to provide a wide variety of communication functionality, such as cellular telephone (e.g., Wideband Code Division Multiple Access/W-CDMA (Universal Mobile Telecommunications System/UMTS), CDMA2000 (IS-856/IS-2000), etc.), WiFi, Bluetooth (e.g., Institute of Electrical and Electronics Engineers/IEEE 802.15.1-2005, Wireless Personal Area Networks), WiMax (e.g. IEEE 802.16-2004), Global Positioning Systems (GPS), spread spectrum (e.g., 900 MHz), and other radio frequency (RF) telephony purposes. The communication module 497 may communicate any data associated with facilitating image processing, including motion data, focus strength metrics, maps, features extracted in image operations, template input, sample input, and so on, or combinations thereof.

Additionally, any data associated with facilitating image processing may be stored in the storage 488, may be displayed via the applications 490, stored in the memory 492, captured via the image capture device 494, displayed in the display 496, and/or implemented via the CPU 498. For example, motion data (e.g., eye-tracking data, etc.), focus strength metrics (e.g., numerical values, sizes, colors, peripheral areas, scan patterns, maps, etc.), threshold values (e.g., threshold relative value, threshold numerical value, threshold color, threshold size, etc.), image operation data (e.g., prioritization data, neglect data, signature data, etc.) and/or the communication data (e.g., communication settings, etc.) may be captured, stored, displayed, and/or implemented using the storage 488, the applications 490, the memory 492, the image capture device 494, the display 496, the CPU 498, and so on, or combinations thereof.

Additionally, the illustrated logic architecture 481 includes a user interface module 499. The user interface module 499 may provide any desired interface, such as a graphical user interface, a command line interface, and so on, or combinations thereof. The user interface module 499 may provide access to one or more settings associated with facilitating, image processing. The settings may include options to define, for example, motion tracking data (e.g., types of motion data, etc.), parameters to determine focus strength metrics (e.g., a focal point, a focal pixel, a focal area, property types, etc.), an image capture device (e.g., select a camera etc.), an observable area (e.g., part of the field of view), a display (e.g., mobile platforms, etc.), adjustment parameters (e.g., color, size, etc), peripheral area parameters (e.g., distances from focal point, etc.), scan pattern parameters (e.g., merge, average, join, join according to sequence, smooth, etc.), map parameters (e.g., scan pattern map, heat map, etc.) image operation parameters (e.g., prioritization, neglecting, signature data, etc.), communication and/or storage parameters (e.g., which data to store, where to store the data, which data to communicate, etc.). The settings may include automatic settings (e.g., automatically provide maps, adjustment, peripheral areas, scan pattern smoothing, etc.), manual settings (e.g., request the user to manually select and/or confirm implementation of adjustment, etc.), and so on, or combinations thereof.

While examples have shown separate modules for illustration purposes, it is should be understood that one or more of the modules of the logic architecture 481 may be implemented one or more combined modules, such as a single module including one or more of the motion module 483, the gaze metric module 485, the adjustment module 487, the peripheral area module 489, the scan pattern module 491, the map generation module 493, the image operation module 495, the communication module 497, and/or the user interface module 499. In addition, it should be understood that one or more logic components of the apparatus 402 may be on-platform, off-platform, and/or reside in the satire or different real and/or virtual space as the apparatus 402. For example, focus metric module 485 may reside in a computing cloud environment on a server while one or more of the other modules of the logic architecture 481 may reside on a computing platform where the user is physically located, and vice versa, or combinations thereof. Accordingly, the modules may be functionally separate modules, processes, and/or threads, may run on the same computing device and/or distributed across multiple devices to run concurrently, simultaneously, in parallel, and/or sequentially, may be combined into one or more independent logic blocks or executables, and/or are described as separate components for ease of illustration.

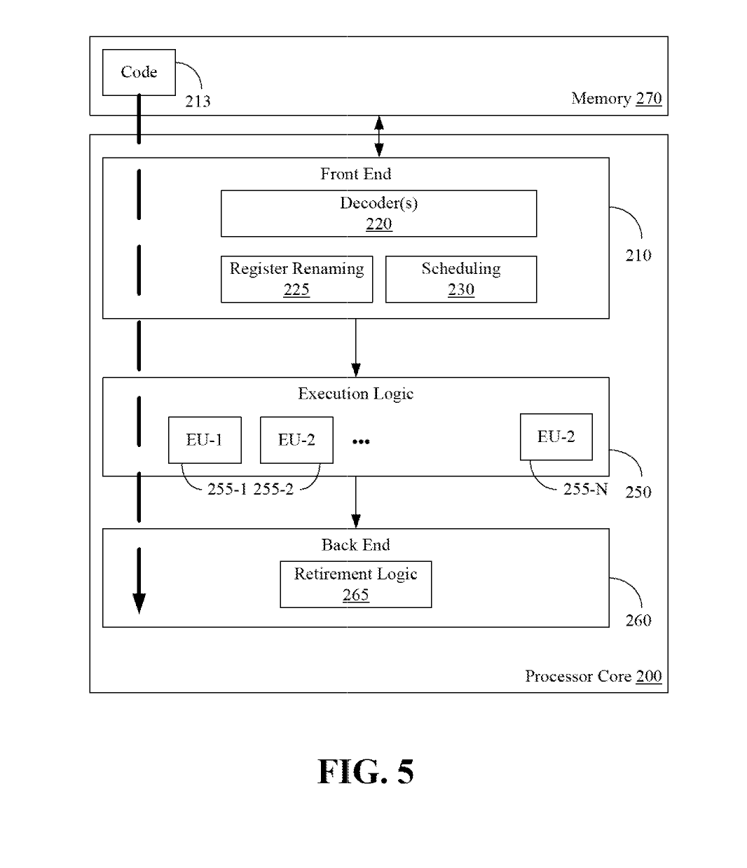

Turning now to FIG. 5, a processor core 200 according to one embodiment is shown. The processor core 200 may be the core for any type of processor, such as a micro-processor, an embedded processor, is digital signal processor (DSP), a network processor, or other device to execute code to implement the technologies describe herein. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context (or “logical processor”) per core.

FIG. 5 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the logic architecture 481 (FIG. 4), already discussed. The processor core 200 follows a program sequence of instructions indicated by the code 213. Each instruction may enter a front end portion 210 and be processed by one or inure decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that may perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, any registers (not shown) modified by the execution logic 250.

Although not illustrated in FIG. 5, a processing element may include other elements on chip with the processor core 200. For example, as processing element may include memory control logic along with the processor core 200. The processing element may include I/O control logic and/or may include I/O control logic integrated with memory control logic. The processing element may also include one or more caches.

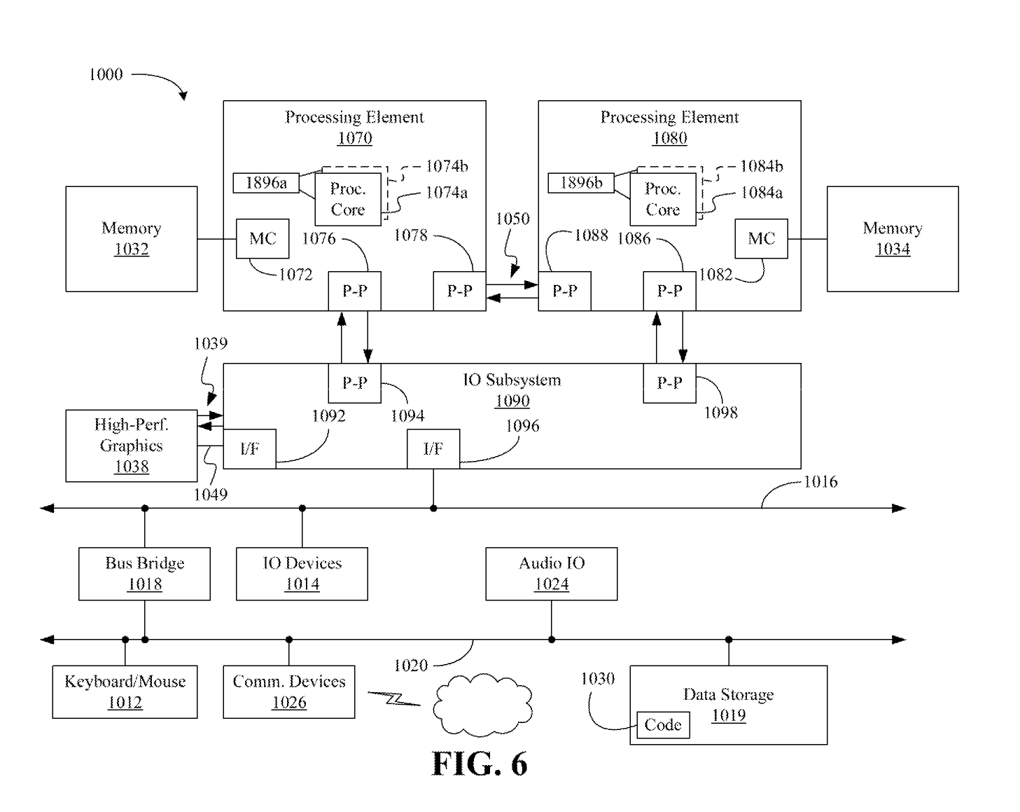

FIG. 6 shows a block diagram of a system 1000 in accordance with an embodiment. Shown in FIG. 6 is a multiprocessor system 1000 that includes as first processing element 1070 and as second processing element 1080. While two processing elements 1070 and 1080 are shown, it is to be understood that an embodiment of system 1000 may also include only one such processing element.

System 1000 is illustrated as a point-to-point interconnect system, herein the first processing element 1070 and second processing element 1080 are coupled via a point-to-point interconnect 1050. It should be understood that any or all of the interconnects illustrated in FIG. 6 may be implemented as a multi-drop has rather than point-to-point interconnect.

As shown in FIG. 6, each of processing elements 1070 and 1080 may be multicore processors, including first and second processor cores processor cores 1074a and 1074b and processor cores 1084a and 1084b). Such cores 1074, 1074b, 1084a, 1084b may be configured to execute instruction code in to manner similar to that discussed above in connection with FIG. 5.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080 it is to be understood that the scope is not so limited. In other embodiments, one or more additional processing elements may be present in as given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as e.g., graphics accelerators or digital signal processing (DSP) units), field programmable gate arrays, or any other processing element. There may be a variety of differences between die processing elements 1070, 1080 in terms of a spectrum of metrics of merit including architectural, microarchitectural, thermal, power consumption characteristics, and the like. These differences may effectively manifest themselves as asymmetry and heterogeneity amongst tale processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include as MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC logic 1072 and 1082 is illustrated as integrated into the processing elements 1070, 1080, for alternative embodiments the MC logic may be discrete logic, outside the processing elements 1070, 1080 rather than integrated therein.

The first processing element 1070 and the second processing element 1080 may be coupled to an I/O subsystem 1090 via P-P interconnects 1076, 1086 and 1084, respectively. As shown in FIG. 10, the I/O subsystem 1090 includes P-P interfaces 1094 and 1098. Furthermore, I/O subsystem 1090 includes an interface 1092 to couple I/O subsystem 1090 with as high performance graphics engine 1038. In one embodiment, bus 1049 may be used to couple graphics engine 1038 to I/O subs stem 1090. Alternately, a point-to-point interconnect 1039 may couple these components.

In turn, I/O subsystem 1090 may be coupled to a first bus 1016 via an interface 1096. In one embodiment, the first bus 1016 may be a peripheral Component Interconnect (PCI) bus, or a bus such as a PCI Express bus or another third generation I/O interconnect bus, although the scope is not so limited.

As shown in FIG. 6, various I/O devices 1014 such as the display 16 (FIG. 1) and/or the display 496 (FIG. 4) may be coupled to the first bus 1016, along with a bus bridge 1018 which may couple the first bus 1016 to as second bus 1020. In one embodiment, the second bus 1020 may be a low pin count (LPC) bus. Various devices may be coupled to the second bus 1020 including, for example, a keyboard/mouse 1012, communication device(s) 1026 (which may in turn be in communication with a computer network), and a data storage unit 1019 such as a disk drive or other mass storage device which may include code 1030, in one embodiment. The code 1030 may include instructions for per/brining embodiments of one or more of the methods described above. Thus, the illustrated code 1030 may implement the logic, architecture 481 (FIG. 4), already discussed. Further, an as I/O 1024 may be coupled to second bus 1020.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

### Additional Notes and Examples

Examples may include subject matter such as a method, means for performing acts of the method, at least one machine-readable medium including instructions that, when performed by a machine cause the machine to performs acts of the method, or an apparatus or system facilitate image processing according to embodiments and examples described herein.

Example 1 is as an apparatus to facilitate image processing, comprising an image capture device to capture user motion data when the user observes an image, a motion module to identify the user motion data, and a focus metric module to determine a focus strength metric based on the user motion data, wherein the focus strength metric corresponds to a focus area in the image and is to be utilized in an image processing operation.

Example 2 includes the subject matter of Example 1 and further optionally includes the motion module to identify user motion data including eye-tracking data.

Example 3 includes the subject matter of any of Example 1 to Example 2 and further optionally includes the focus strength metric to be provided to one or more of a feature extraction module and an image recognition module, and wherein at least the focus area is to be prioritized in the image processing operation if the focus strength metric satisfies a threshold value and is to be neglected if the focus strength metric does not satisfy the threshold value.

Example 4 includes the subject matter of any of Example 1 to Example 3 and further optionally includes the focus metric module including one or more of an adjustment module to adjust a property of the focus strength metric based on a focus duration at the focus area, a peripheral area module to account for a peripheral area corresponding to the focus area to determine the focus strength metric, or a scan pattern module to account for a variation in a scan pattern to determine the focus strength metric.

Example 5 includes the subject matter of any of Example 1 to Example 4 and further optionally includes as map generation module to form a map based on the focus strength metrics, wherein the map includes one or more of a scan pattern map and a heat map.

Example 6 is a computer-implemented method of facilitating image processing, comprising identifying user motion data when a user observes an image and determining a focus strength metric based on the user motion data, wherein the focus strength metric corresponds to a focus area in the image and is utilized in an image processing operation.

Example 7 includes the subject matter of Example 6 wind further optionally includes identifying user motion data including eye-tracking data.

Example 8 includes the subject matter of any of Example 6 to Example 7 and further optionally includes adjusting a property of the focus strength metric based on a gaze duration at the focus area.

Example 9 includes the subject matter of any of Example 6 to Example 8 and further optionally includes adjusting one or more of a size and a color tot the focus strength metric.

Example 10 includes the subject matter of any of Example 6 to Example 9 and further optionally includes accounting for a peripheral area corresponding to the focus area to determine the focus strength metric.

Example 11 includes the subject matter of any of Example 6 to Example 10 and further optionally includes imparting a color to the focus area in one part of the visible spectrum and imparting a color to the peripheral area in another part of the visible spectrum.

Example 12 includes the subject matter of any of Example 6 to Example 11 and further optionally includes imparting a color in an approximate 620 to 750 nm range of the visible spectrum to the focus area and imparting a color in an approximate 380 to 450 nm range of the visible spectrum to an outermost peripheral area.

Example 13 includes the subject matter of any of Example 6 to Example 12 and further optionally includes accounting for a variation in a scan pattern to determine the focus strength metric.

Example 14 includes the subject matter of any of Example 6 to Example 13 and further optionally includes providing the focus strength metric to one or more of a feature extraction operation and an image recognition operation.

Example 15 includes the subject matter of any of Example 6 to Example 14 and further optionally includes prioritizing at least the focus area in the image processing operation if the focus strength metric satisfies a threshold value and neglecting at least the focus area if the focus strength metric does not satisfy the threshold value.

Example 16 includes the subject matter of any of Example 6 to Example 15 and further optionally includes forming a map based on the focus strength metric, wherein the map includes one or more of a scan pattern map and a heat map.

Example 17 is at least one computer-readable medium including one or more instructions that when executed on one or more computing devices causes the one or more computing devices to perform the method of any of Example 6 to Example 16.

Example 18 is an apparatus including means for performing the method of any of Example 6 to Example 16.

Various embodiments may be implemented using hardware elements, software elements, or a combination of both. Examples of hardware elements May include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC drips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC Chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g. circuits) are set forth in order to describe example embodiments, it should be apparent to one skilled in the art that embodiments may be practiced without, or with variation of, these specific details. The description is thus to be regarded as illustrative instead of limiting.

Some embodiments mar be implemented, for example, using a machine or tangible computer-readable medium or article which may store an instruction or a set of instructions that, if executed by a machine, may cause the machine to perform a method and/or operations in accordance with the embodiments. Such as machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW) optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g. electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. Additionally, it is understood that the indefinite articles “a” or “an” carry the meaning of “one or more” or “at least one”. In addition, as used in this application and in the claims, a list of items joined by the terms one or more or and “at least one of” can mean any combination of the listed terms. For example, the phrases “one or more of A, B or C” can mean A; B; C; A and B; A and C; B and C; or A, B and C.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, the specification, and following claims.

1-25. (canceled)

26. An apparatus to facilitate image processing comprising:
an image capture device to capture user motion data when a user observes an image;
a motion module to identify the user motion data; and
a focus metric module to determine a focus strength metric based on the user motion data, wherein the focus strength metric corresponds to a focus area in the image and is to be utilized in an image processing operation.

27. The apparatus of claim 26, wherein the motion module is to identify user motion data including eye-tracking data.

28. The apparatus of claim 26, wherein the focus strength metric is to be provided to one or more of a feature extraction module or an image recognition module, and wherein at least the focus area is to be prioritized in the image processing operation if the focus strength metric satisfies a threshold value and is to be neglected if the focus strength metric does not satisfy the threshold value.

29. The apparatus of claim 26, wherein the focus metric module is to include one or more of:
an adjustment module to adjust a property of the focus strength metric based on a focus duration at the focus area;
a peripheral area module to account for a peripheral area corresponding to the focus area to determine the focus strength metric; or
a scan pattern module to account for a variation in a scan pattern to determine the focus strength metric.

30. The apparatus of claim 26, further including a map generation module to form a map based on the focus strength metric, wherein the map includes one or more of a scan pattern map and a heat map.

31. A computer-implemented method of facilitating image processing comprising:
identifying user motion data when a user observes an image; and
determining a focus strength metric based on the user motion data, wherein the focus strength metric corresponds to a focus area in the image and is utilized in an image processing operation.

32. The method of claim 31, further including identifying user motion data including eye-tracking data.

33. The method of claim 31, further including adjusting a property of the focus strength metric based on a gaze duration at the focus area.

34. The method of claim 33, further including adjusting one or more of a size or a color for the focus strength metric.

35. The method of claim 31, further including accounting for a peripheral area corresponding to the focus area to determine the focus strength metric.

36. The method of claim 35, further including imparting a color to the focus area in one part of the visible spectrum and imparting a color to the peripheral area in another part of the visible spectrum.

37. The method of claim 35, further including imparting a color in an approximate 620 to 750 nm range of the visible spectrum to the focus area and imparting a color in an approximate 380 to 450 nm range of the visible spectrum to an outermost peripheral area.

38. The method of claim 31, further including accounting for a variation in a scan pattern to determine the focus strength metric.

39. The method of claim 31, further including providing the focus strength metric to one or more of a feature extraction operation or an image recognition operation.

40. The method of claim 39, further including prioritizing at least the focus area in the image processing operation if the focus strength metric satisfies a threshold value and neglecting at least the focus area if the focus strength metric does not satisfy the threshold value.

41. The method of claim 31, further including forming a map based on the focus strength metric, wherein the map includes one or more of a scan pattern map or a heat map.

42. At least one computer-readable medium comprising one or more instructions that when executed on a computing device cause the computing device to:
identify user motion data when a user observes an image; and
determine a focus strength metric based on the user motion data, wherein the focus strength metric corresponds to a focus area in the image and is to be utilized in an image processing operation.

43. The at least one medium of claim 42, wherein when executed the one or more instructions cause the computing device to identify user motion data including eye-tracking data.

44. The at least one medium of claim 42, wherein when executed the one or more instructions cause the computing device to adjust a property of the focus strength metric based on a gaze duration at the focus area.

45. The at least one medium of claim 42, wherein when executed the one or more instructions cause the computing device to account for a peripheral area corresponding to the focus area to determine the focus strength metric.

46. The at least one medium of claim 45, wherein when executed the one or more instructions cause the computing device to impart a color to the focus area in one part of the visible spectrum and to impart a color to the peripheral area in another part of the visible spectrum.

47. The at least one medium of claim 42, wherein when executed the one or more instructions cause the computing device to account for a variation in a scan pattern to determine the focus strength metric.

48. The at least one medium of claim 42, wherein when executed the one or more instructions cause the computing device to provide the focus strength metric to one or more of a feature extraction operation or an image recognition operation.

49. The at least one medium of claim 48, wherein when executed the one or more instructions cause the computing device to prioritize at least the focus area in the image processing operation if the strength metric satisfies a threshold value and to neglect at least the focus area if the strength metric does not satisfy the threshold value.

50. The at least one medium of claim 42, wherein when executed the one or more instructions cause the computing device to form a map based on the focus strength metric, wherein the map includes one or more of a scan pattern map and a heat map.
